(19) United States
(12) Patent Application Publication
(10) Pub. No.: US 2013/0148332 A1
(43) Pub. Date: Jun. 13, 2013

(54) ILLUMINATION DEVICE AND DISPLAY DEVICE

(71) Applicant: Yuuki Namekata, Osaka-shi (JP)

(72) Inventor: Yuuki Namekata, Osaka-shi (JP)

(73) Assignee: SHARP KABUSHIKI KAISHA, OSAKA (JP)

(21) Appl. No.: 13/817,944

(22) PCT Filed: Sep. 8, 2011
(86) PCT No.: PCT/JP2011/070451

§ 371 Date: Feb. 20, 2013

(30) Foreign Application Priority Data
Sep. 15, 2010 (JP) 2010-207375

(51) Int. Cl. G09F 13/14; F21V 7/00

(52) U.S. Cl. CPC G09F 13/14; F21V 7/00
USPC 362/97.1; 362/296.01

(57) ABSTRACT

An illumination device capable of suppressing the generation of uneven luminescence is provided. The illumination device comprises: an LED package (25); a reflective sheet (23) with an exposure hole (23c) for exposing the LED package (25); and a pressing member (27) for pressing down the reflective sheet (23). The pressing member (27) has a sheet pressing section (27a) arranged so to surround the circumference of the LED package (25), and an edge section (23d) of the exposure hole (23c) is pressed down by the sheet pressing section (27a).

### TECHNICAL FIELD

The present invention relates to an illumination device and a display device.

### BACKGROUND ART

In a liquid crystal display device that is one of display devices, a liquid crystal display panel for displaying an image is not light emissive, accordingly, an illumination device is disposed on a rear side (side opposite to a display side of the liquid crystal display panel) of the liquid crystal display panel and the liquid crystal display panel is illuminated with light from the illumination device. Meanwhile, the illumination device disposed on the rear side of the liquid crystal display panel is called a backlight unit or the like, for example.

As a light source used in a backlight unit, a cold-cathode fluorescent lamp, in which mercury or xenon is sealed in a fluorescent tube, is known. However, in a case where the cold-cathode fluorescent lamp is used as a light source of a backlight unit, the light emission brightness and life are insufficient, further, there is a disadvantage that the brightness on a low voltage side declines and it becomes hard to obtain well-balanced light emission.

Accordingly, to solve these disadvantages, a backlight unit is proposed, which instead of the cold-cathode fluorescent lamp, uses an LED (light emitting diode) package as a light source. When an LED package is used as a light source of a backlight unit, the above disadvantages are solved, low power consumption is easily achievable and an environmental load is reducible.

Besides, backlight units are roughly classified into two types of an edge light type and a direct type.

In the edge light type of backlight unit, a light guide plate is disposed right under a liquid crystal display panel (region opposing a rear surface of the liquid crystal display panel) and a light source is disposed to oppose a predetermined side end surface of the light guide plate. In the edge light type of backlight unit, when light is emitted from the light source, the light from the light source is introduced into the light guide plate via the predetermined side end surface. And, the light introduced into the light guide plate is output from a front surface (surface faced to the liquid crystal display panel) of the light guide plate, whereby the liquid crystal display panel is illuminated.

On the other hand, in the direct type of backlight unit, a light source is disposed right under a liquid crystal display panel. Such direct type of backlight unit is advantageous to illuminate a large area with a high output and is often used in a large-sized liquid crystal display device.

Meanwhile, in the direct type of backlight unit that uses an LED package as the light source, to efficiently cast light emitted from the LED package onto the liquid crystal display panel, a reflection sheet is generally used (e.g., see a patent document 1).

As an example, as shown in FIG. 13, usually, an LED package 101 is mounted on a mount surface of a board 102, accordingly, a reflection sheet 103 is disposed on the mount surface of the board 102. And, to prevent the LED package 101 from being covered by the reflection sheet 103, the reflection sheet 103 is provided with an exposure hole 103a, and the LED package 101 is exposed (protruded) from the exposure hole 103a of the reflection sheet 103.

### CITATION LIST

### Patent Literature

PLT1: JP-A-2005-352427

### SUMMARY OF INVENTION

### Technical Problem

However, when the reflection sheet 103 is disposed to cover the mount surface of the board 102 and the LED package 101 is exposed from the exposure hole 103a of the reflection sheet 103, as shown in FIG. 14, there is a case where an edge portion 103b of the exposure hole 103a of the reflection sheet 103 warps up and rises. And, when the edge portion 103b of the exposure hole 103a of the reflection sheet 103 warps up, the light reflection by the reflection sheet 103 is not well performed in a surrounding region of the LED package 101. As a result of this, the brightness of a region corresponding to the surrounding region of the LED package 101 declines, and brightness unevenness occurs.

The present invention has been made to solve the above problems, and it is an object of the present invention to provide an illumination device and a display device that are able to alleviate occurrence of the brightness unevenness.

### Solution to Problem

To achieve the above object, an illumination device according to a first aspect of the present invention includes: a light source; a reflection sheet that is provided with an exposure hole for exposing the light source; and a press member that presses down the reflection sheet. And, the press member includes a sheet press portion that is disposed to surround a circumference of the light source, and an edge portion of the exposure hole of the reflection sheet is pressed down by the sheet press portion.

In the illumination device according to the first aspect, as described above, the press member is provided with the sheet press portion that is disposed to surround the circumference of the light source and the edge portion of the exposure hole of the reflection sheet is pressed down by the sheet press portion, whereby it is possible to make small or remove the warp (rise) of the edge portion of the exposure hole of the reflection sheet. Because of this, the light reflection by the reflection sheet is well performed in the surrounding region of the light source. As a result of this, it becomes possible to alleviate the occurrence of the disadvantage that the brightness unevenness occurs because of a decline of the brightness of a region that corresponds to the surrounding region of the light source.

In the illumination device according to the first aspect, it is preferable that the sheet press portion is composed of an annular body capable of surrounding an entire circumference of the light source. According to this structure, it is possible to press down the entire circumference of the edge portion of the exposure hole of the reflection sheet, accordingly, the occurrence of the warp at the edge portion of the exposure hole of the reflection sheet is more alleviated.

In the illumination device according to the first aspect, it is preferable that the sheet press portion is formed into a shape along a shape of the edge portion of the exposure hole of the reflection sheet. According to this structure, it is possible to surely press down a portion (i.e., the edge portion of the exposure hole of the reflection sheet) which is a part of the entire reflection sheet and where the warp is prone to occur. Meanwhile, for example, in a case where an opening shape of the exposure hole of the reflection sheet is a circular shape, the shape of the edge portion of the exposure hole of the reflection sheet becomes an annular shape, accordingly, it is preferable that the shape of the sheet press portion also is formed into a circular shape. Besides, in a case where the shape of the opening shape of the exposure hole of the reflection sheet is a quadrangular shape, the shape of the edge portion of the exposure hole of the reflection sheet becomes a quadrangular shape, accordingly, it is preferable that the shape of the sheet press portion also is formed into a quadrangular shape.

In the illumination device according to the first aspect, it is preferable that the illumination device further includes a housing that has a bottom portion on a bottom surface of which the reflection sheet is placed; the press member further includes a mount portion that is mounted on the bottom portion of the housing; and the sheet press portion and the mount portion are connected to each other via a connection portion that extends in a direction parallel to the bottom surface of the bottom portion of the housing. According to this structure, by mounting the mount portion on the bottom portion of the housing, it is possible to fix the press member to the bottom portion of the housing.

Besides, the sheet press portion and the mount portion are connected to each other via the connection portion that extends in the direction parallel to the bottom surface of the bottom portion of the housing, accordingly, the mount portion is away from the sheet press portion by a length of the connection portion in the direction parallel to the bottom surface of the bottom portion of the housing. Because of this, a region (region around which the light source is not present) away from the surrounding region of the light source is used as a mount space where to mount the mount portion, accordingly, it is possible to widely secure the mount space. According to this, the degree of freedom of selecting a method for mounting the mount portion increases.

In the structure where the press member further includes the mount portion that is mounted on the bottom portion of the housing, it is preferable that the bottom portion of the housing and the reflection sheet are fastened by the mount portion. According to this structure, the press portion itself is fixed to the bottom portion of the housing, and the reflection sheet also is fixed to the bottom portion of the housing. In other words, it is possible to fix the reflection sheet to the bottom portion of the housing without additionally preparing a fix member and the like for fixing the reflection sheet to the bottom portion of the housing.

In the structure where the press member includes the sheet press portion and the mount portion, the sheet press portion may include a plurality of sheet press portions, the mount portion may include one mount portion, and the plurality of sheet press portions may be connected to the one mount portion. According to this structure, for example, in a case where the one mount portion is connected to two sheet press portions, it is possible to press down the edge portions of two exposure holes of the reflection sheet by means of the one press member. Because of this, it becomes unnecessary to prepare the same number of press members as the number of the exposure holes of the reflection sheet, and the number of components is reduced.

Besides, in the structure where the press member includes the sheet press portion and the mount portion, the sheet press portion may include one sheet press portion, the mount portion may include a plurality of mount portions, and the one sheet press portion may be connected to the plurality of mount portions. According to this structure, the fixing of the press member becomes strong, and it is possible to perform more strongly the pressing-down of the edge portion of the exposure hole of the reflection sheet by means of the sheet press portion.

A display device according to a second aspect of the present invention includes the illumination device according to the first aspect and a display panel that is illuminated with the light from the illumination device.

In the display device having this structure, it is possible to alleviate the occurrence of brightness unevenness.

### Advantageous Effects of Invention

As described above, according to the present invention, it is possible to obtain an illumination device and a display device that are able to alleviate the occurrence of brightness unevenness.

### BRIEF DESCRIPTION OF DRAWINGS

FIG. 1 is an exploded perspective view of a liquid crystal display device (display device) that includes a backlight unit (illumination device) according to a first embodiment of the present invention.

FIG. 2 is a plan view of a press member of the backlight unit according to the first embodiment of the present invention.

FIG. 3 is a side view of the press member of the backlight unit according to the first embodiment of the present invention.

FIG. 4 is a plan view showing a state where the press member of the backlight unit according to the first embodiment of the present invention presses down a reflection sheet.

FIG. 5 is a sectional view showing a state where the press member of the backlight unit according to the first embodiment of the present invention presses down a reflection sheet.

FIG. 6 is a view for describing a method for mounting the press member of the backlight unit according to the first embodiment of the present invention.

FIG. 7 is a view for describing a modification of the press member of the backlight unit according to the first embodiment of the present invention.

FIG. 8 is a view for describing a modification of the press member of the backlight unit according to the first embodiment of the present invention.

FIG. 9 is a view for describing a modification of the press member of the backlight unit according to the first embodiment of the present invention.

FIG. 10 is a view for describing a modification of the press member of the backlight unit according to the first embodiment of the present invention.

FIG. 11 is a plan view showing a state where a press member of a backlight unit according to a second embodiment of the present invention presses down a reflection sheet.

FIG. 12 is a plan view showing a state where a press member of a backlight unit according to a third embodiment of the present invention presses down a reflection sheet.

FIG. 13 is a view showing around a light source of a conventional backlight unit.

FIG. 14 is a view for describing a conventional problem.

### DESCRIPTION OF EMBODIMENTS

### First Embodiment

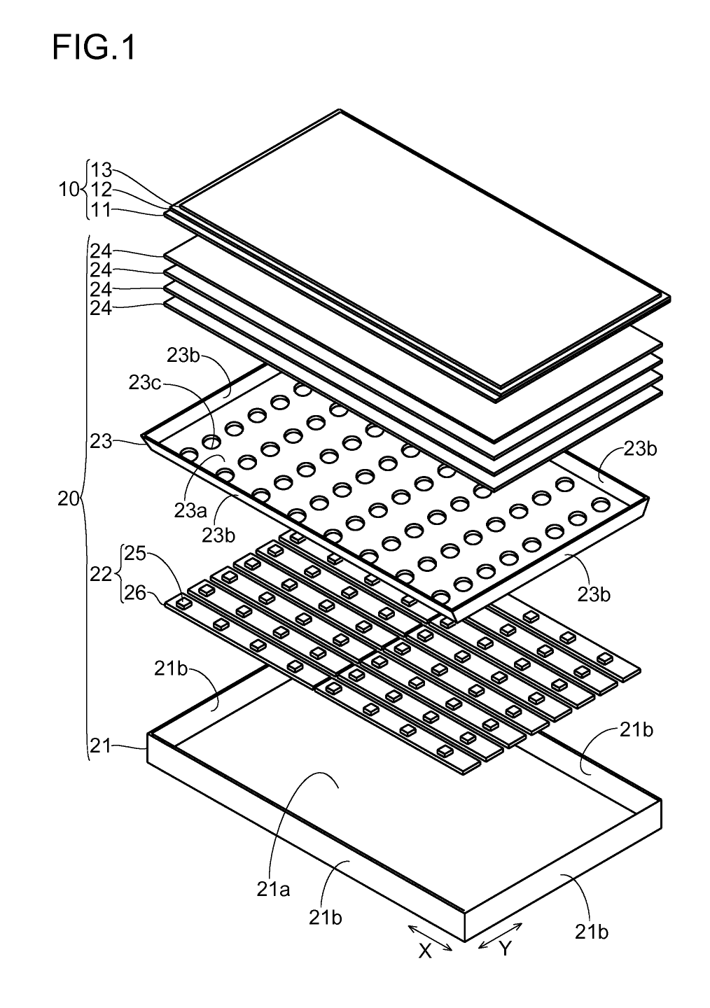

A structure of a display device including an illumination device according to a first embodiment of the present invention is described with reference to FIG. 1 to FIG. 6.

This display device is a liquid crystal display device and, as shown in FIG. 1, includes at least: a liquid crystal display panel (illuminated body) 10 that displays an image; and a backlight unit 20 that is disposed on a rear side opposite to a display side of the liquid crystal display panel 10. Meanwhile, the liquid crystal display panel 10 is an example of a “display panel” of the present invention, and the backlight unit 20 is an example of an “illumination device” of the present invention.

The liquid crystal display panel 10 has a display region where an image is actually displayed and a non-display region that is a surrounding region of the display region. And, in the display region of the liquid crystal display panel 10, a plurality of pixels are disposed in a matrix shape.

Each of the plurality of pixels is driven by a switching device, a pixel electrode, a common electrode and the like. Meanwhile, for the sake of easy understanding of the figure, the switching device, the pixel electrode and the common electrode are not shown, and also a wiring electrically connected to these is not shown.

The switching device is composed of a TFT (thin film transistor), a gate of the switching device is connected to a gate line (scan line), and a source of the switching device is connected to a source line (data line). Besides, the pixel electrode is connected to a drain of the switching device, and the common electrode is disposed to oppose the pixel electrode, further, liquid crystal (not shown) is sandwiched between the pixel electrode and the common electrode. Meanwhile, the switching device is separately disposed for each pixel and the pixel electrode also is separately disposed for each pixel. On the other hand, as indicated by the name, the common electrode is common to each pixel.

Besides, the backlight unit 20 employs the direct type, emits white backlight in a surface shape and illuminates the rear surface of the liquid crystal display panel 10 with no unevenness by means of the backlight.

And, during the display operation, based on an image signal, an optical characteristic (light transmittance) of the liquid crystal is changed for every pixel. Specifically, for each pixel, predetermined electric power is supplied to the pixel electrode via the switching device, whereby an electric field is generated between the pixel electrode and the common electrode. And, the orientation of the liquid crystal, that is, the transmittance for light passing through the liquid crystal is changed by the electric field generated between the pixel electrode and the common electrode.

Because of this, when the backlight is output from the backlight unit 20 and the rear surface of the liquid crystal display panel 10 is illuminated with the backlight, the penetration amount of the backlight passing through the liquid crystal display panel 10 is different for every pixel. According to this, a desired image is displayed on the display surface of the liquid crystal display panel 10.

Hereinafter, structures of the liquid crystal display panel 10 and backlight unit 20 are described in more detail.

The liquid crystal display panel 10 includes at least two transparent boards 11, 12. One transparent board 11 is called an active matrix board, and the other transparent board 12 is disposed to oppose the transparent board 11, accordingly, there is a case where the other transparent board is called an opposite board or there is a case where the other transparent board is called a color filter board.

On a predetermined surface of the one transparent board 11, the switching device and the pixel electrode are formed, and also the gate line (scan line) and the source line (data line) electrically connected to these are formed. Besides, on a predetermined surface of the other transparent board 12, the common electrode is formed. Meanwhile, on the predetermined surface of the other transparent board 12, besides the common electrode, a color filter is further formed if necessary. And, the respective predetermined surfaces of the two transparent electrodes 11, 12 are covered by an orientation film (not shown) capable of orienting the liquid crystal in a specific direction.

Besides, the two transparent boards 11, 12 are attached to each other via a seal member (not shown) such that the respective predetermined surfaces oppose each other. And, the liquid crystal is sealed between the two transparent boards 11, 12. According to this, the state is obtained, where the liquid crystal is sandwiched between the pixel electrode and the common electrode (between the orientation film for covering the predetermined surface of the one transparent board 11 and the orientation film for covering the predetermined surface of the other transparent board 12).

Further, respective outer sizes of the two transparent boards 11, 12 are different from each other, and the outer size of the transparent board 11 is larger than the outer size of the transparent electrode 12. Accordingly, the two transparent boards 11, 12 are attached to each other, however, respective predetermined ends of the transparent boards 11, 12 do not match each other, and a portion of the predetermined surface of the transparent board 11 is exposed from the transparent board 12. This exposed portion of the predetermined surface of the transparent board 11 is a region of the non-display region and used to electrically connect a driver (not shown) to the transparent board 11.

Besides, a light polarization sheet 13 for transmitting a light wave only in a specific vibration direction is attached by one to each of surfaces opposite to the predetermined surfaces (surfaces facing the liquid crystal) of the two transparent boards 11, 12. And, respective transmission axes of the two light polarization sheets 13 are deviated from each other by about 90°.

The backlight unit 20 disposed on the rear side of the liquid crystal display panel 10 includes at least: a back chassis 21; a light emitting module 22; a reflection sheet 23; and an optical sheet 24. Meanwhile, the back chassis 21 is an example of a “housing” of the present invention.

The back chassis 21 is formed into a substantially box shape with a side opposing the liquid crystal display panel 10 opened. In other words, the back chassis 21 includes a bottom portion 21a that has a substantially rectangular shape when viewed from top (when viewed from the liquid crystal display panel 10 in a planar manner) and a side portion 12b that is disposed upright on an outer circumference of the bottom portion 21a. And, a region surrounded by the bottom portion 21a and side portion 21b of the back chassis 21 is used as a housing region.

The light emitting module 22 is intended to generate the light that is the basis of the backlight, a plurality of the light emitting modules are housed in the housing region of the back chassis 21 and fixed to the bottom portion 21a of the back chassis 21. And, in the state where the backlight unit 20 is disposed on the rear side of the liquid crystal display panel 10, the light emitting module 22 is disposed right under (region that opposes the rear surface of the liquid crystal display panel 10) the liquid crystal display panel 10.

The light emitting module 22 has a structure that includes two or more LED packages 25 as the light source each of which emits white LED light and the two or more LED packages 25 are mounted on a mount surface of the same LED board 26 that is formed into a strip shape. Besides, the two or more LED packages 25 are ranged in a line along a long-edge direction of the LED board 26 and connected in series with each other.

Meanwhile, a method for changing the LED light emitted from the LED package 25 to the white color light is not especially limited, and a combination of a fluorescer for converting blue LED light into yellow light and a blue LED may be used as the LED package 25; and a combination of fluorescers for converting blue LED light into respective color light of green and red and a blue LED may be used as the LED package 25. Further, a combination of three kinds of LEDs of a blue LED, a green LED and a red LED may be used as the LED package 25.

Further, also the number of the LED packages 25 mounted on the mount surface of the same LED board 26 is not especially limited, and is changeable in accordance with use.

Besides, it is already described that the plurality of light emitting modules 22 are housed in the housing region of the back chassis 21, and the plurality of light emitting modules 22 are ranged two dimensionally in an X direction (long-edge direction of the back chassis 21) and a Y direction (short-edge direction of the back chassis 21) that are parallel to a bottom surface of the bottom portion 21a of the back chassis 21. Meanwhile, in this state, a long-edge direction of the LED board 26 matches the X direction and a short-edge direction of the LED board 26 matches the Y direction.

And, light emitting modules 22 adjacent to each other in the X direction are electrically connected to each other via a not-shown connector. In other words, the LED boards 26, which are respectively included in one light emitting module 22 and the other light emitting module 22 adjacent to each other in the X direction, are electrically connected to each other via the connector.

The reflection sheet 23 is intended to reflect the LED light emitted from the LED package 25 to the liquid crystal display panel 10, and housed in the housing region of the back chassis 21 together with the light emitting module 22. A shape of the reflection sheet 23 has a bottom portion 23a having a substantially rectangular shape when viewed from top and a side portion 23b disposed upward to be inclined on an outer circumference of the bottom portion 23a.

And, in the state where the reflection sheet 23 is housed in the housing region of the back chassis 21, the bottom portion 23a of the reflection sheet 23 is placed on the bottom surface of the bottom portion 21a of the back chassis 21 with the LED board 26 interposed between them. In other words, the bottom portion 23a of the reflection sheet 23 covers the mount surface of the LED board 26 (also inclusive of a surface of the bottom surface of the bottom portion 21a of the back chassis 21 that does not overlap the LED board 26). On the other hand, the side portion 23b of the reflection sheet 23 covers an inner surface of the side portion 21b of the back chassis 21.

Meanwhile, if the entire mount surface of the LED board 26 is covered by means of the bottom portion 23a of the reflection sheet 23, the LED package 25 mounted on the mount surface of the LED board 26 is also covered by the bottom portion 23a of the reflection sheet 23. Because of this, the light emission of the LED package 25 is discouraged. Accordingly, to expose the LED package 25 toward the liquid crystal display panel 10, the bottom portion 23a of the reflection sheet 23 is provided with the same number of exposure holes 23c having a circular opening shape as the number of the LED packages 25. And, the LED package 25 is exposed (protruded) by one from each of these exposure holes 23c of the reflection sheet 23 toward the liquid crystal display panel 10.

The optical sheet 24 is a group of sheets that include a diffusion sheet, a prism sheet and the like, and is disposed to close the open side of the back chassis 21. In other words, the optical sheet 24 is disposed on a side that opposes the bottom surface (bottom surface of the bottom portion 23a of the reflection sheet 23) of the bottom portion 21a of the back chassis 21, thereby covering the light emitting module 22 from the liquid crystal display panel 10 side. Accordingly, the LED light emitted from the LED package 25 enters the optical sheet 24 to undergo light diffusion and collection, thereafter shines on the rear surface of the liquid crystal display panel 10. Meanwhile, the kind and number of the optical sheets 24 are suitably changed in accordance with usage.

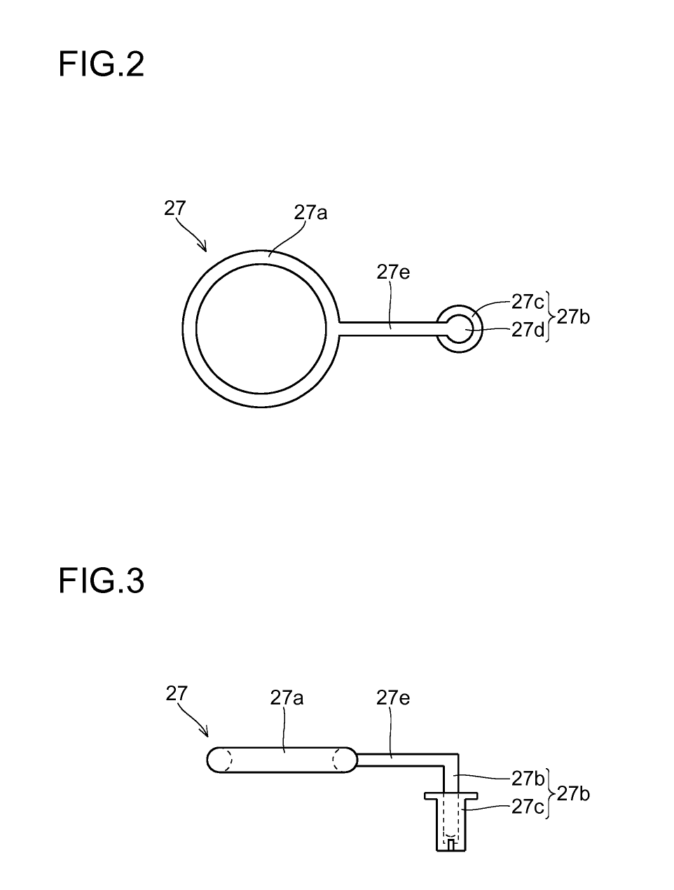

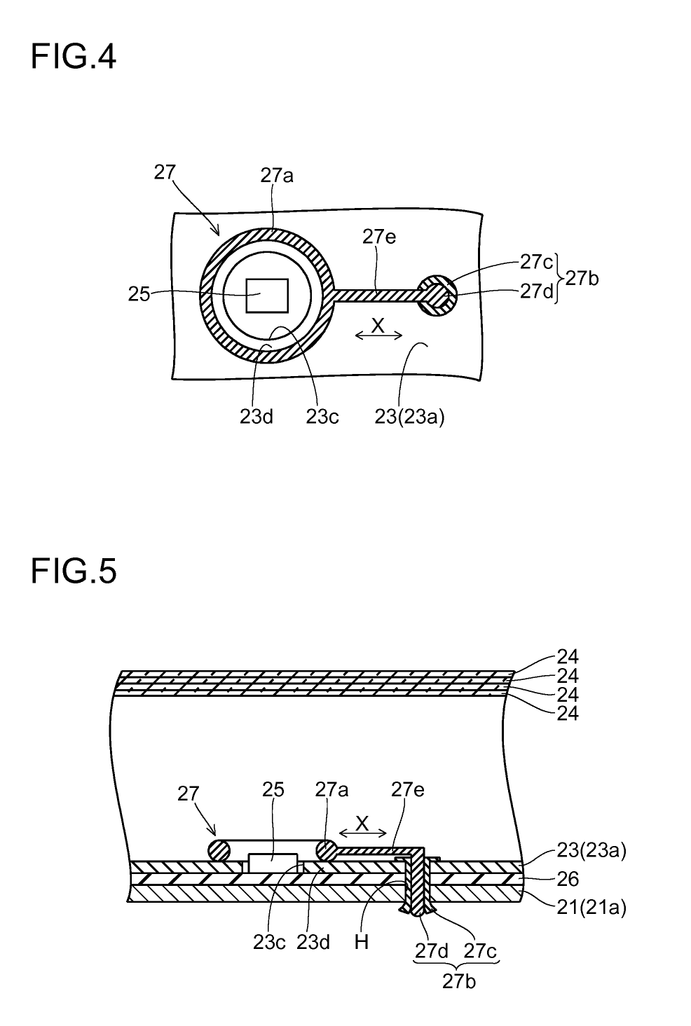

Here, in the first embodiment, a press member 27 shown in FIG. 2 and FIG. 3 is further disposed in the backlight unit 20. And, as shown in FIG. 4 and FIG. 5, by using the press member 27, the reflection sheet 23 is pressed down and the reflection sheet 23 is fixed to the bottom portion 21a of the back chassis 21. Meanwhile, FIG. 4 is not a sectional view, however, for the sake of easy understanding of the figure, hatching is applied to a portion that corresponds to the press member 27.

This press member 27 uses a high reflection material (e.g., a polycarbonate resin that includes a titanium oxide, a barium sulfate and the like) as a constituent material, and has one sheet press portion 27a that actually presses down the reflection sheet 23 and one mount portion 27b that is mounted on the bottom portion 21a of the back chassis 21.

The sheet press portion 27a is composed of a continuous circular annular body and disposed to surround the entire circumference of the LED package 25 that is exposed from the exposure hole 23c of the reflection sheet 23. In other words, a shape of the sheet press portion 27a is formed into a annular shape (annular shape along the opening shape of the exposure hole 23c of the reflection sheet 23) along a shape of the edge portion 23d of the exposure hole 23c of the reflection sheet 23. And, by means of this sheet press portion 27a, the edge portion 23d of the exposure hole 23c of the reflection sheet 23 is pressed down from the optical sheet 24 side (liquid crystal display panel 10 side).

The mount portion 27b has substantially a shape like a push rivet (fastener member). In other words, a structural body, which includes a cylinder body 27c having a split pin-shaped tip end and a shaft body 27d fitted into the cylinder body 27c, is used as the mount portion 27d, the shaft body 27d is fitted into the cylinder body 27c and pressed into as it is, whereby the tip end (the split pin-shaped portion) of the cylinder body 27c is widened. And, the mount portion 27b is mounted on the bottom portion 21a of the back chassis 21, whereby the press member 27 itself is fixed to the bottom portion 21a of the back chassis 21 and the reflection sheet 23 is fixed to the bottom portion 21a of the back chassis 21.

As a specific mount structure, a mount hole H for mounting the mount portion 27b is formed beforehand through the bottom portion 21a of the back chassis 21. Likewise, the mount hole H is also formed beforehand through the bottom portion 23a of the reflection sheet 23 and the LED board 26. And, in the state where the mount portion 27b is inserted in the mount hole H, the tip end of the cylinder body 27c is widened (the shaft body 27d is pressed in the cylinder body 27c), whereby the mount portion 27b is mounted on the bottom portion 21a of the back chassis 21.

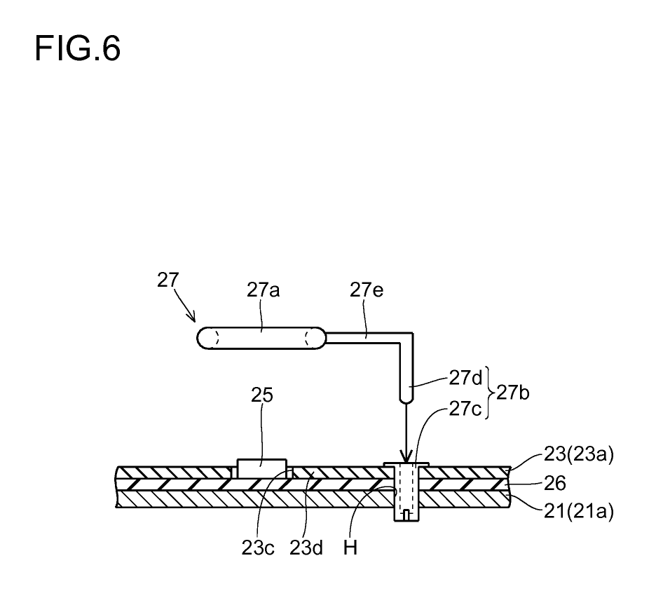

Meanwhile, in the mount procedure, as shown in FIG. 6, first, the cylinder body 27c demounted from the shaft body 27d, that is, the cylinder body 27c whose tip end is not widened is inserted into the mount hole H. Thereafter, the shaft body 27d is fitted into the cylinder body 27c. At this time, the shaft body 27d is pressed into until the tip end of the cylinder body 27c is widened. According to this, as shown in FIG. 5, the mount portion 27b is mounted on the bottom portion 21a of the back chassis 21.

When the mount portion 27b is mounted on the bottom portion 21a of the back chassis 21 in this way, the press member 27 itself is fixed to the bottom portion 21a of the back chassis 21, and the bottom portion 21a of the back chassis 21, the LED board 26 and the bottom portion 23a of the reflection sheet 23 are fastened by the mount portion 27b. In other words, the reflection sheet 23 is fixed to the bottom portion 21a of the back chassis 21.

Besides, the sheet press portion 27a and the mount portion 27b are connected to each other via a connection portion 27e. This connection portion 27e is formed to extend in a direction (X direction) parallel to the bottom surface (bottom surface of the bottom portion 21a of the back chassis 21) of the bottom portion 23a of the reflection sheet 23. And, the sheet press portion 27a is connected to one end of the connection portion 27e in the X direction, while the mount portion 27b (shaft body 27d) is connected to the other end opposite to the one end of the connection portion 27e in the X direction. In other words, the sheet press portion 27a and the mount portion 27b are away from each other by a length of the connection portion 27e in the X direction. Because of this, the mount hole H into which the mount portion 27b is inserted is not formed through the edge portion 23d of the exposure hole 23c of the reflection sheet 23 but formed through a portion (portion different from the edge portion 23d of the exposure hole 23c of the reflection sheet 23) away from the edge portion 23d of the exposure hole 23c of the reflection sheet 23.

Besides, in the first embodiment, the number of the press members 27 is equal to the number of the exposure holes 23c of the reflection sheet 23. And, the press member is allocated by one to each of the exposure holes 23c of the reflection sheet 23.

In the first embodiment, as described above, the sheet press portion 27a disposed to surround the circumference of the LED package 25 is formed on the press member 27, and the edge portion 23d of the exposure hole 23c of the reflection sheet 23 is pressed down by means of the sheet press portion 27a, whereby it is possible to make small or remove the warp (rise) of the edge portion 23d of the exposure hole 23c of the reflection sheet 23. According to this, the light reflection by the reflection sheet 23 is well performed in the surrounding region of the LED package 25. As a result of this, it becomes possible to alleviate the occurrence of the disadvantage that the brightness unevenness occurs because of the decline of brightness in the region that corresponds to the surrounding region of the LED package 25.

Besides, in the first embodiment, as described above, the sheet press portion 27a is composed of the annular body capable of surrounding the entire circumference of the LED package 25, accordingly, it is possible to press down the entire circumference of the edge portion 23d of the exposure hole 23c of the reflection sheet 23. According to this, the occurrence of the warp of the edge portion 23d of the exposure hole 23c of the reflection sheet 23 is more alleviated.

Besides, in the first embodiment, as described above, the sheet press portion 27a is formed into the shape along the shape of the edge portion 23d of the exposure hole 23c of the refection sheet 23, accordingly, it is possible to surely press down a portion (i.e., the edge portion 23d of the exposure hole 23c of the reflection sheet 23) which is a part of the entire reflection sheet 23 and where the warp is prone to occur by means of the sheet press portion 27a.

Besides, in the first embodiment, as described above, by connecting the mount portion 27b mounted on the bottom portion 21a of the back chassis 21 to the sheet press portion 27a, the mount portion 27b is mounted on the bottom portion 21a of the back chassis 21, whereby it possible to easily fix the press member 27 to the bottom portion 21a of the back chassis 21.

And, in this case, the sheet press portion 27a and the mount portion 27b are connected to each other via the connection portion 27e that extends in the X direction, accordingly, the mount portion 27b is away from the sheet press portion 27a by the length of the connection portion 27e in the X direction. Because of this, the region (region around which the LED package 25 is not present) away from the surrounding region of the LED package 25 is used as a mount space for mounting the mount portion 27b, accordingly, it is possible to widen the mount space. According to this, the degree of freedom of selecting the method for mounting the mount portion 27b increases.

Besides, in the first embodiment, as described above, by making it possible to perform the fastening of the bottom portion 21a of the back chassis 21 and the bottom portion 23a of the reflection sheet 23 by means of the mount portion 27b, it is possible to fix the reflection sheet 23 to the bottom portion 21a of the back chassis 21 without additionally preparing a fix member and the like for fixing the reflection sheet 23 to the bottom portion 21a of the back chassis 21.

Meanwhile, a modification of the first embodiment is conceivable as follows.

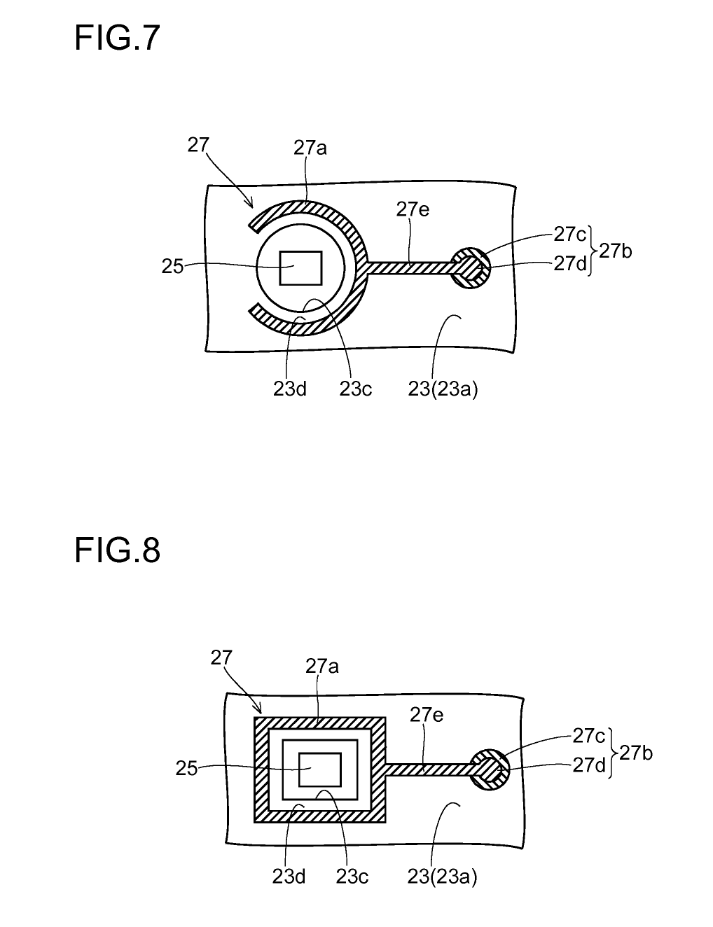

In other words, in the structure of the first embodiment, as shown in FIG. 7, a cutout may be formed at a portion of the sheet press portion 27a. Meanwhile, FIG. 7 is not a sectional view, however, for the sake of easy understanding of the figure, hatching is applied to the portion that corresponds to the press member 27.

Besides, in the structure of the first embodiment, in a case where the exposure hole 23c of the reflection sheet 23 is opened into a shape different from the circular shape, in accordance with that, the shape of the sheet press portion 27a may be changed. For example, as shown in FIG. 8, if the opening shape of the exposure hole 23c of the reflection sheet 23 is a quadrangular shape, the shape of the edge portion 23d of the exposure hole 23c of the reflection sheet 23 becomes a quadrangular shape, accordingly, it is preferable to form the shape of the sheet press portion 27a into a quadrangular shape. Meanwhile, FIG. 8 is not a sectional view, however, for the sake of easy understanding of the figure, hatching is applied to the portion that corresponds to the press member 27.

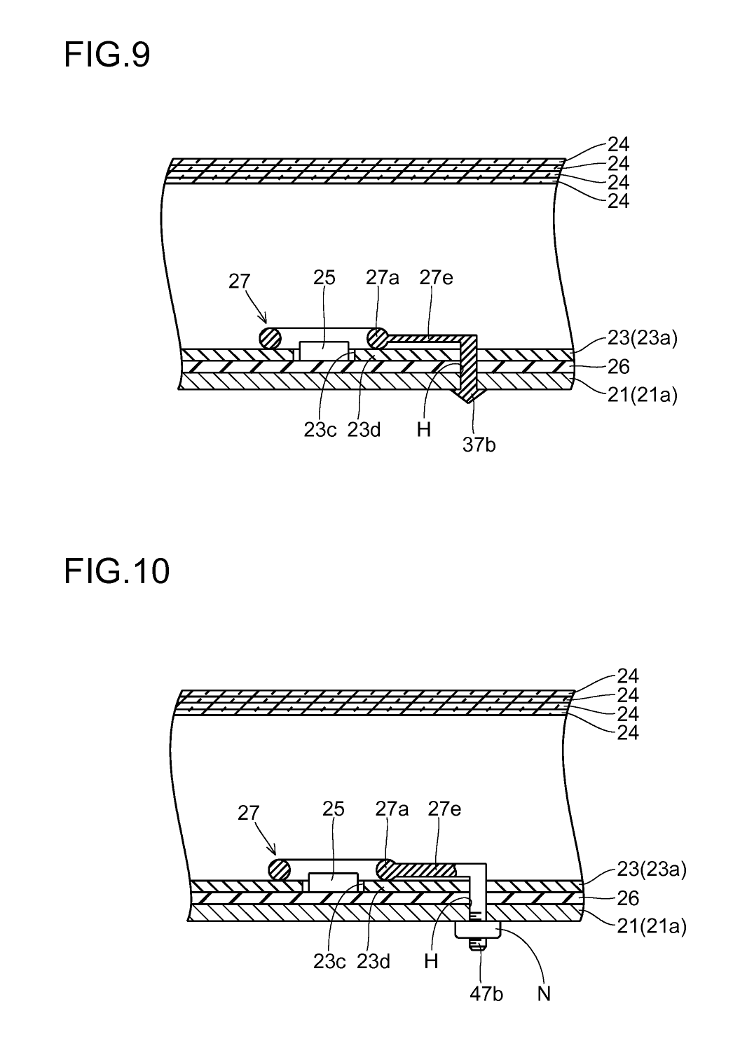

Besides, in the structure of the first embodiment, the mount portion 27b of the push rivet structure may not be formed on the press member 27 but, as shown in FIG. 9, a mount portion 37b, which has an engagement piece engageable with the bottom portion 21a of the back chassis 21, may be formed on the mount member 27. In this case, by engaging the mount portion 37b inserted in the mount hole H of the bottom portion 21a of the back chassis 21 with the bottom portion 21a of the back chassis 21, the press member 27 is fixed to the bottom portion 21a of the back chassis 21.

Or, as shown in FIG. 10, a mount portion 47b to be screwed into a nut (screw member) N may be formed on the press member 27. In this case, by screwing the nut N onto the mount portion 47b inserted in the mount hole H of the bottom portion 21a of the back chassis 21, the press member 27 is fixed to the bottom portion 21a of the back chassis 21.

### Second Embodiment

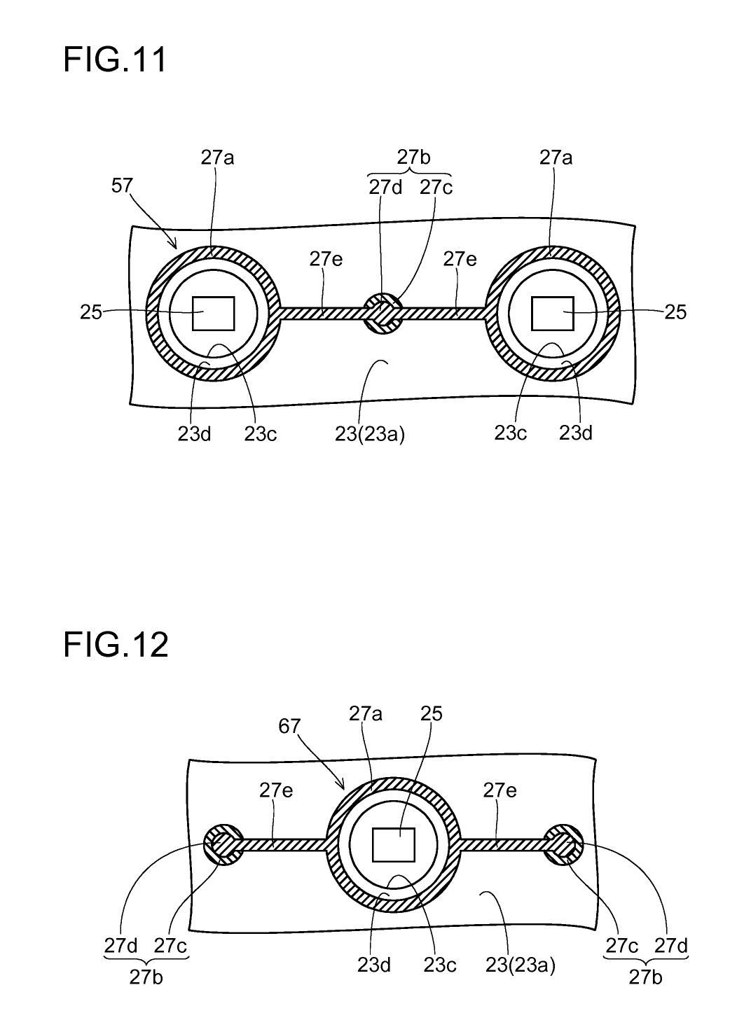

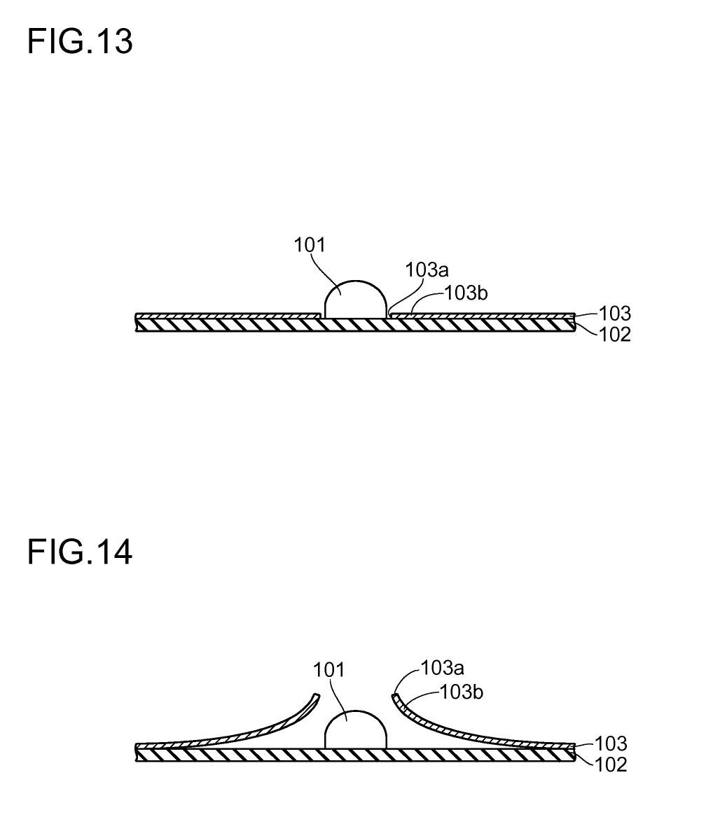

Hereinafter, with reference to FIG. 11, a structure of a press member 57 according to a second embodiment is described. Meanwhile, of the press member 57 according to the second embodiment, portions having the same functions as the first embodiment are indicated by the same reference numbers, and detailed description of them is skipped. Besides, FIG. 11 is not a sectional view, however, for the sake of easy understanding of the figure, hatching is applied to a portion that corresponds to the press member 57.

The press member 57 according to the second embodiment, as shown in FIG. 11, integrally has two sheet press portions 27a. In other words, a structure is employed, in which the two sheet press portions 27a are connected to the one mount portion 27b.

The other structures of the second embodiment are the same as the first embodiment.

In the second embodiment, by using the press member 57 described above, it is possible to press down the edge portions 23d of the two exposure holes 23c of the reflection sheet 23 by means of the one press member 57. Because of this, it becomes unnecessary to prepare the same number of the press members 57 as the number of the exposure holes 23c of the reflection sheet 23, whereby the number of components is reduced.

The other effects of the second embodiment are the same as the first embodiment.

### Third Embodiment

Hereinafter, with reference to FIG. 12, a structure of a press member 67 according to a third embodiment is described. Meanwhile, of the press member 67 according to the third embodiment, portions having the same functions as the first embodiment are indicated by the same reference numbers, and detailed description of them is skipped. Besides, FIG. 12 is not a sectional view, however, for the sake of easy understanding of the figure, hatching is applied to a portion that corresponds to the press member 67.

The press member 67 according to the third embodiment, as shown in FIG. 12, integrally has two mount portions 27b. In other words, a structure is employed, in which the one sheet press portion 27a is connected to the two mount portions 27b.

The other structures of the third embodiment are the same as the first embodiment.

In the third embodiment, by using the press member 67 described above, the fixing of the press member 67 becomes strong, and it is possible to perform more strongly the pressing-down of the edge portion 23d of the exposure hole 23c of the reflection sheet 23 by means of the sheet press portion 67a.

The other effects of the third embodiment are the same as the first embodiment.

It should be considered that the embodiments disclosed this time are examples in all respects and are not limiting. The scope of the present invention is not indicated by the above description of the embodiments but by the claims, and all modifications within the scope of the claims and the meaning equivalent to the claims are covered.

For example, in the above embodiments, the example is described, in which the present invention is applied to an illumination device disposed in a liquid crystal display device, however, the present invention is not limited to this, and may be applied to an illumination device disposed in a display device other than the liquid crystal display device.

### REFERENCE SIGNS LIST

10 liquid crystal display panel (display panel)
20 backlight unit (illumination device)
21 back chassis (housing)
21a bottom portion
23 reflection sheet
23c exposure hole
23d edge portion
25 LED package (light source)
27, 57, 67 press members
27a sheet press portion
27b, 37b, 47bmount portions
27e connection portion

1. An illumination device comprising:
a light source;
a reflection sheet that is provided with an exposure hole for exposing the light source; and
a press member that presses down the reflection sheet, wherein
the press member includes a sheet press portion that is disposed to surround a circumference of the light source; and
an edge portion of the exposure hole of the reflection sheet is pressed down by the sheet press portion.

2. The illumination device according to claim 1, wherein
the sheet press portion is composed of an annular body capable of surrounding an entire circumference of the light source.

3. The illumination device according to claim 1, wherein
the sheet press portion is formed into a shape along a shape of the edge portion of the exposure hole of the reflection sheet.

4. The illumination device according to claim 1, further comprising a housing that has a bottom portion on a bottom surface of which the reflection sheet is placed, wherein
the press member further includes a mount portion that is mounted on the bottom portion of the housing; and
the sheet press portion and the mount portion are connected to each other via a connection portion that extends in a direction parallel to the bottom surface of the bottom portion of the housing.

5. The illumination device according to claim 4, wherein
the bottom portion of the housing and the reflection sheet are fastened by the mount portion.

6. The illumination device according to claim 4, wherein
the sheet press portion includes a plurality of sheet press portions and the mount portion includes one mount portion; and
the plurality of sheet press portions are connected to the one mount portion.

7. The illumination device according to claim 4, wherein
the sheet press portion includes one sheet press portion and the mount portion includes a plurality of mount portions; and
the one sheet press portion is connected to the plurality of mount portions.

8. A display device comprising:
an illumination device according to claim 1; and
a display panel that is illuminated with light from the illumination device.
